(19) United States
(12) Patent Application Publication
(10) Pub. No.: US 2026/0278054 A1
(43) Pub. Date: Sep. 17, 2026

(54) Biometric System Disruption Personal Gear, Modules And Methods

(71) Applicant: David Vitalli, Brentwood, TN (US)

(72) Inventor: David Vitalli, Brentwood, TN (US)

(21) Appl. No.: 19/334,599

(22) Filed: Sep. 19, 2025

Related U.S. Application Data
(63) Continuation-in-part of application No. 19/081,505, filed on Mar. 17, 2025, now abandoned.

(51) Int. Cl. G06F 21/32; H05B 47/105

(52) U.S. Cl. CPC G06F 21/32; H05B 47/105

(57) ABSTRACT

Personal gear and attachable modules configured to disrupt biometric systems, including facial recognition systems, are provided. Devices incorporate infrared emitters, control circuitry, power systems, and thermal-management features to corrupt capture of facial features across a range of lighting conditions, preventing reliable extraction or reconstruction by biometric systems. Embodiments include eyewear, headgear, jewelry, handhelds, and mobile-device attachments. Emission patterns are modulated, randomized, or sensor-responsive, with optional camera-detection activation. Materials and ergonomics support discreet, prolonged wear. Methods of use are also provided.

### CROSS REFERENCE TO RELATED APPLICATIONS

This application claims the benefit of U.S. Ser. No. 19/081,505, filed on Mar. 17, 2025, which is hereby incorporated by reference herein in its entirety.

### FIELD OF THE INVENTION

The invention relates to personal wearable and/or holdable and modular technologies, specifically providing personal gear, such as headgear (e.g., hats, visors), integrated with multiple infrared (IR) light-emitting diodes (LEDs) strategically placed to and operated to disrupt biometric systems, such as facial recognition systems. The devices and methods incorporate advanced heat dissipation systems, dynamic power management systems, and enhanced ergonomic features for prolonged wear.

### BACKGROUND OF THE INVENTION

Facial recognition technology and other biometric systems are widely used in surveillance, security, and personal devices. While beneficial in various applications, it raises concerns about privacy and unauthorized surveillance. Conventional anti-surveillance methods, such as masks or tinted visors, can draw attention and can be impractical for everyday wear in some situations. This invention provides a discreet and highly effective means of counteracting biometric systems, such as facial recognition systems, including their algorithms, while maintaining the aesthetics and functionality of various types of personal gear and modules.

Problems exist in the art because current IR devices are not discreet and safe and they do not provide sustainable and wearable disruption of facial recognition and other biometric systems.

Solutions to these problems are provided by certain embodiments of this invention with an integrated stealth form factor, pulse width modulation and thermal feedback, artificial intelligence and/or random modulation of the IR emissions, and multi-angle IR coverage. The result of the invention in certain embodiments is reliable biometric system (e.g., facial recognition) sensor corruption that is also immune to artificial intelligence correction.

### SUMMARY OF THE INVENTION

The invention integrates an IR LED array within personal gear and/or modules to obscure critical facial landmarks required for biometric systems, such as facial recognition. The design ensures adequate to maximum coverage, effective disruption (e.g., interference), and long-term comfort through optimized heat dissipation and power management.

Examples of embodiments of the present invention overcome the limitations of the past by integrating infrared technology into personal gear and modules, providing continuous and undetectable disruption to camera apparatus and/or associated algorithms while remaining aesthetically neutral. Applied infrared light obscures facial features visible to camera apparatus (e.g., obscures facial features that recognition algorithms rely on to make comparisons and identifications). In particular, the infrared light in certain embodiments may overexpose and/or distort facial features in camera images and/or data and render facial recognition less effective. The invention overcomes the drawbacks of certain conventional privacy protection methods.

Certain embodiments of the personal gear of this invention feature an infrared light disruption system integrated into a discreet device. These embodiments can provide continuous and undetectable disruption to cameras while appearing aesthetically neutral.

Certain embodiments of the personal gear and modules maintain the appearance of standard personal gear while incorporating the functionality described herein.

All sorts of applicable personal gear can be used. This includes various forms of wearable and holdable gear such as clothing, headgear (e.g., hats, caps, visors) and other objects worn on the head, as well as jewelry (e.g., necklaces, rings, earrings, clip-ons, bracelets, lapel pins, broaches, wrist watches), and holdable devices such as handheld mobile phones, mobile phone covers, tablets, and dedicated handheld devices, etc. In certain embodiments, a dedicated device in the form of an IR emitter module with the IR emitters and other components of this invention that is handheld or attached to the body, a device, clothing or other personal gear can also be used. In addition, combinations of these embodiments of personal gear can be used together for effective disruption pursuant to this invention.

Certain of the examples of embodiments comprise particular components, features and uses (some of which can be combined in one or more components or separated into two or more components that achieve the same functions and results):

### I. IR LED Emitter Components, Features And Use:

These examples of embodiments use multiple IR LED emitters. In some embodiments, these are distributed along the top (e.g., upper rim) of the front of the personal gear, the bottom of the personal gear, the sides of the personal gear, or combinations of such, or otherwise pointed at or emitting around or in proximity to the face (e.g., providing IR light between a person and a facial recognition system), to enhance facial landmark disruption. Other configurations of the multiple IR LED emitters can be used.

An example of number of IR LED emitters is between 2 and 24, although more (and less) can be used in some applications. An example of number of IR LED emitters is between 10 and 20, and another example of number of IR LED emitters is between 16 and 18. Another example of number of IR LED emitters in some applications is between 8 and 12. It should be understood, however, that this invention is not limited to a certain number of IR LED emitters.

The wavelength emitted from the multiple IR LED emitters can vary in different embodiments and any IR emission or combinations of emissions can be used. One example of range is from about 780 nm to about 1100 nm of the near-infrared spectrum. Another example of range is from about 780 nm to about 950 nm of the near-infrared spectrum. Another example of range is from about 850 nm to about 940 nm. In certain examples of embodiments, the IR LED emitters emit at about 850 nm wavelength, which is invisible to the human eye but effective against facial recognition cameras. In other examples of embodiments, the IR LED emitters emit at about 940 nm. In other examples of embodiments, the personal gear or module uses a combination of IR LED emitters, such as some IR LED emitters that emit at about 850 nm wavelength and other IR LED emitters that emit at about 940 nm wavelength. Certain IR LED emitters can be used that emit at multiple wavelengths Other combinations of IR LED emitters that emit at different wavelengths can be used in some applications.

In certain embodiments, the IR LED emitters have an approximately 120-degree beam angle to ensure a fulsome facial coverage or other desired effect. Other beam angles or emitting features, and different combinations of such, also can be used to obtain effective facial coverage or other desired effect.

The invention permits flexibility in how the IR emitters are arranged and their angles of coverage. Thus, the disruption provided by this invention can apply regardless of the emitter orientation (e.g., regardless of angular positioning of the IR emitters, including downward, upward, outward, diagonal, or dynamically adjustable) as long as there is sufficient coverage to provide disruption.

### II. Power Management And Battery Components, Features And Use:

The power source should provide sufficient power (e.g., a battery with a capacity of about 100 mAh to about 1000 mAh, and in some embodiments 300 mAh to 500 mAh), long-lasting operation, and effective heat management, while fitting compactly into personal gear or modules or other components.

An exemplary embodiment uses 8 to 12 IR LED emitters, a battery capacity of about 300 mAh to about 500 mAh, which produces an estimated runtime of about 3 to about 5 hours of continuous use, and about 5 to about 7 hours in a power-saving mode. Other embodiments with three IR LED emitters have a battery capacity of about 100 mAh and an estimated runtime of continuous use of about 1 to about 2 hours.

Battery integration into the personal gear or module in some embodiments includes embedding a 300-500 mAh lithium ion battery inside personal gear or module, routing the power cables discreetly through the personal gear or module to the IR LED emitters, use of a microcontroller to regulate the LED intensity dynamically, and including use of a compact Battery Management System (BMS) board to protect against overcharging and heat issues. Other batteries and arrangements of components can be used.

The examples of embodiments use high-capacity lithium-ion (or lithium-pulse) rechargeable batteries (e.g., a capacity to accommodate multiple IR LED emitters and their functions).

Certain examples of batteries include lithium-ion or lithium-polymer batteries, with a capacity of 300 mAh to 500 mAh, voltage of 3.7V, ultrathin and flexible batteries (e.g., about 4 to about 6 mm thick and about 40 mm in length) to fit within the personal gear or module.

Certain embodiments use a USB-C charging port (or other charging port) integrated into the personal gear or module (e.g., underside, interior), with the port discreetly integrated into the personal gear or module side or back, and for discreet recharging.

Certain embodiments use an Advanced Power Controller (APC) integrated circuit that dynamically adjusts the IR LED emitters'intensity to balance battery life, power consumption and effectiveness.

Certain embodiments use a Battery Management System (BMS) that prevents overheating and optimizes battery life. Examples of embodiments of the BMS include (a) a smart power controller that dynamically adjusts IR LED intensity to conserve the battery, (b) overcharge protection to ensure safe recharging via the USB-C port; (c) thermal sensors to monitor temperature and regulate power to prevent overheating; and (d) an auto-shut-off feature when the IR LED emitters are inactive, which saves power.

Certain embodiments provide power distribution to the IR LED emitters that is maintained at a steady output (e.g., 3.7V) for consistent IR LED brightness. Current-limiting resistors are used to prevent excess power draw from the IR LED emitters. A Pulse Modulation Controller integrated circuit (PWM Control, or Pulse Modulation Controller module) can also be used in some embodiments and it operates to provide pulses of IR light from the IR LED emitters, which reduces continuous power drain and extends battery life.

Certain embodiments provide these pulses or intermittent use of IR light from the IR LED emitters that may be efficient and effective in disrupting camera-based facial recognition. These can include random pulses, non-random pulses, time-based pulses, combination pulses, other types of pulses and intermittent use (e.g., varying intensity, varying wavelength) and/or combinations of these. Some embodiments permit the user to choose what type of pulse, if any, is used by a switch or other selection component. Other embodiments may include manual, automatic, and/or artificial intelligence (“AI”) controlled switching of pulses (e.g., switching from non-random to time-based) to disrupt camera-based facial recognition systems. One or more of the circuits/controllers identified above (e.g., PCB, APC Controller, PWM Control) alone or together can provide this capability. Some embodiments can also apply AI and/or algorithms to adapt and respond to a given power, battery, facial recognition system, and/or other environmental situation.

Certain embodiments have camera detectors, or camera-likelihood detectors, from the current location, known camera placements (e.g., public areas), surroundings, detection of IR focusing means, image sensors, lens reflections, etc., that can be used to turn the device on or off or select a type of emission or other mode (e.g., wavelength, intensity, pulse or non-pulse or combination). In the examples of embodiments, the IR emission method used is one that will disrupt the actual camera-based facial recognition of interest and/or that is likely to be encountered.

Examples of embodiments of this invention use active, real-time disruption with the components described herein. The threat from software, AI or other means adapting to IR interference devices and overcoming any disruption to still provide reconstructed facial data is overcome by certain embodiments of this invention on the hardware level because they effectively disrupt the raw visual input to the facial recognition system itself.

Certain of the examples of embodiments provide flash sequences of the infrared lights that operate in a continuous loop. Each cycle of the ignition sequence generates a unique light pattern that is randomized or altered from the previous cycle. This ensures that the flashing behavior cannot be predicted, mapped, or adapted to by external imaging or AI-based recognition systems.

Some of the examples of embodiments have an increased number of LEDs for more effective facial coverage and a battery system that provides sufficient power, long-lasting operation, and effective heat management while fitting compactly into the personal gear or modules.

Certain of the examples of embodiments embed an 300 mAh-500 mAh Li-Ion battery discreetly inside the personal gear or module. In these embodiments, the power cables are run discreetly through the personal gear or module to the LEDs. They also use a microcontroller to regulate LED intensity dynamically and include a compact BMS board to protect against overcharging and heat issues.

### III. Heat Dissipation And Safety Components, Features And Use:

These examples of embodiments use integrated ventilation slots (e.g., openings) and micro-perforations on the top of the personal gear or module, or in other effective placements, to regulate heat.

Certain embodiments use temperature regulation sensors (e.g., in conjunction with a Printed Circuit Board (PCB) and/or the APC) that actively monitor IR LED heat levels and adjust output accordingly.

Certain embodiments use adaptive thermal modulation systems to prevent thermal buildup while preserving performance, which is controlled by an onboard microcontroller. The microcontroller actively monitors the temperature of the IR LED diodes (via integrated thermistors or diode junction temperature sensing) and dynamically adjusts the strobe pulse frequency and duty cycle of the LED driving signals. Rather than driving the LEDs in steady-state, the controller drives them in a rapid pulsed IR strobe within a range of approximately 5-20 Hz. This means the IR LED emitters blink on and off faster than the human eye can perceive (infrared being invisible regardless), but fast enough to appear as a near-constant flood to a camera. The duty cycle (the ON vs. OFF time ratio of each pulse) is modulated based on real-time temperature feedback: if the LEDs'temperature approaches a defined threshold, the controller automatically shortens the ON duration or lengthens the OFF interval of pulses to reduce heat accumulation. Conversely, when temperature is within safe limits, the system can use a higher duty cycle (longer pulses) to maximize IR output. This adaptive Pulse Width Modulation or PWM-based drive ensures the LEDs operate within safe thermal limits at all times, avoiding overheating or damage.

In these embodiments, the adaptive logic leverages PWM thermal management techniques: temperature sensors feed into a control loop that adjusts LED PWM duty cycle to counteract any rise in junction temperature. By reducing the duty cycle when the LEDs get too warm, the system lowers the average power dissipation (allowing the diodes to cool) while still emitting periodic IR flashes. This approach improves the stability and reliability of the IR emitters under all conditions, effectively extending LED lifespan and preventing performance degradation. In summary, the adaptive thermal modulation ensures that the anti-recognition glasses deliver a consistent, effective IR output for facial masking, without overheating, through intelligent real-time adjustment of strobe frequency and duty cycle based on LED temperature. This guarantees that the device remains safe and functional over prolonged use, all while maintaining its full disruptive capability against facial recognition systems.

Certain embodiments use personal gear or a module that is constructed from heat-resistant, thermally conductive polymer for enhanced durability and comfort. Thus, thermally conductive, heat-resistant, IR-transparent and/or IR-diffusing materials are examples of materials for the personal gear or module. Thus, examples of personal gear or module and housing material is selected for thermal conductivity, infrared transparency or diffusion, and structural integrity under sustained heat output.

IV. Other Design And Aesthetic Components, Features And Use:

These examples of embodiments use flush-mounted IR LED emitters to ensure that the personal gear or module, maintains a low-profile, everyday appearance. However, other IR LED placements and types (e.g., flush-mounted, dome-type, surface-mounted, lens-containing) and combinations of such can be used.

Certain embodiments use a matte black finish for the components and/or the personal gear or modules that minimizes reflections and enhances discretion.

Certain embodiments use a lightweight ergonomic structure of the personal gear or module that ensures comfortable extended wear or use (e.g., about 3 or more hours without discomfort).

Certain embodiments also use optical filters, reflectors, or coatings as non-emissive methods to reduce the efficacy of any facial recognition system or device.

Embodiments of certain personal gear or module may comprise material-level protection for any materials used. Thus, thermally conductive, heat-resistant, IR-transparent, and/or IR-diffusing materials can be used. In certain of these embodiments, the housing material is selected for thermal conductivity, infrared transparency or diffusion, and/or structural integrity under sustained heat output.

Certain of the examples of embodiments comprise an expansive 850 nm wavelength, 120-degree beam angle IR LED array, an optimized power source, advanced heat dissipation, and enhanced ergonomic features that are highly effective against facial recognition, ensure better battery life, and maintain aesthetic discretion.

V. Combinations with Other Biometric System Disrupters

The embodiments of this invention can be combined with other components and/or methods to achieve additional biometric system disruption. These include voice manipulators (e.g., pitch alteration, muffling, or voice-altering software and components that evade automatic speaker verification systems) and other facial, mannerism, or additional body part obfuscation (e.g., side profile alteration, photoplethysmography alteration (PPG), heavy makeup, wigs, fingerprint alteration, eye changes, gaze alteration, gate changes, mood detection changes, iris or retina pattern changes (e.g., special contact lenses)).

Thus, in certain of these embodiments, protection against biometric data harvesting beyond facial recognition is also provided. This may include disruption of eye-tracking, gaze analysis, 3D depth mapping, iris scans, and/or other biometric data collection techniques. In some of these embodiments, the device is configured to interfere with, obstruct, and/or degrade acquisition of biometric data including but not limited to facial recognition, gaze tracking, iris scanning, 3D depth mapping, and/or photoplethysmography.

VI. Selected Examples of Embodiments

In certain examples of embodiments, personal gear or modules that disrupt facial landmark detection by a facial recognition system are provided. The personal gear or modules comprise: (a) multiple IR LED emitters, each IR LED emitting at a 850 nm wavelength and having 120-degree beam angles, each IR LED emitters embedded into and mounted flush with, and positioned on the personal gear or module; (c) a power source for providing power to each of the IR LED emitters, the power source comprising multiple power source components that work in concert.

The power source components in these embodiments comprise: (i) a high-capacity rechargeable lithium battery, which battery is integrated within the personal gear or modules, and which battery provides power that is used by each of the IR LED emitters; (ii) a USB-C charging interface, which charging interface is positioned within the personal gear or module, and which charging interface charges the battery; (iii) a battery management system, which battery management system is integrated within the personal gear or module and is connected to the battery, and which battery management system works with other power source components to regulate power distribution, intensity of each of the IR LED emitters, and heat dissipation; (iv) multiple heat dissipators, the dissipators comprising ventilation slots and micro-perforations in the top of the personal gear or module that dissipate heat to prevent overheating of each of the IR LED emitters; (v) temperature regulation sensors, which sensors are embedded in the personal gear or module, and which sensors work with other power source components to adjust the output of each of the IR LED emitters based on temperature to prevent overheating of each of the IR LED emitters; (vi) a dynamic power controller that work with other power source components to adjust the intensity of each of the IR LED emitters to maximize facial recognition disruption while preserving battery life; and (vii) an electrical circuit connecting the battery, charging interface, battery management system, sensors, controller, and each of the IR LED emitters.

These embodiments also have personal gear or module that comprise: (a) a matte black finish to provide aesthetic discretion; (b) heat-resistant, thermally conductive polymer for durability and comfort; and (c) wherein the multiple IR LED emitters of the personal gear or module disrupt the facial landmark detection by the facial recognition system under various light conditions.

In these embodiments, certain examples are where (a) the battery is a lithium-ion or lithium-polymer battery with a capacity of about 300 mAh to about 500 mAh, a voltage of about 3.7V, and is about 4 mm to about 6 mm thick and about 40 mm in length; (b) the battery management system further provides overcharge protection to ensure safe recharging and an automatic shut-off of each of the IR LED emitters when they are inactive to save power; (c) the battery management system and the dynamic power controller are provided on a single printed circuit board; (d) the power source further comprises a voltage regulator that maintains a steady approximately 3.7V output for each of the IR LED emitters; (e) the power source further comprises current-limiting resistors that prevent excess power draw from each of the IR LED emitters; (f) the power source further comprises pulse modulation control that provides pulsing IR LED operation to reduce continuous power drain and extend battery life; and/or (g) the power source further comprises a power-saving mode that limits the intensity and/or duration of IR LED use to extend battery life.

Each of these examples of embodiments of the personal gear or module can be used in methods of disrupting facial landmark detection by a facial recognition system. These methods use the Examples of embodiments of the personal gear or module provided above and comprise: (a) orienting the personal gear or module with respect to the facial recognition system, the personal gear or module comprising a power source that can be powered on to provide power to infrared light sources embedded in the personal gear or module; (b) powering on the personal gear or module to provide the power to the infrared light sources from the power source; (c) providing infrared light from infrared light sources towards the facial landmark detection by the facial recognition system; and (d) disrupting the facial landmark detection by the facial recognition system using the infrared light from the infrared light sources.

These examples of embodiments also can be used in other methods of disrupting facial landmark detection by a facial recognition system. These other methods use the examples of embodiments of the personal gear or module provided above and comprise: (a) providing pulses of infrared light to the person's face using the personal gear or module; and (b) disrupting the image of the person's face captured by the facial recognition system with the pulses of infrared light so that the facial recognition system fails to identify the person's face.

Advantages of the embodiments of this invention are described and apparent throughout this specification. For example, certain embodiments provide continuous interference with facial recognition systems, effectively overexposing camera sensors while remaining invisible to the naked eye. Unlike previous anti-surveillance solutions, the device ensures that privacy protection is seamless, discreet, and effective in a variety of lighting conditions. Other advantages of embodiments of this invention include that they can operate at the hardware level and thus disrupt raw visual input that can make the disruption harder to overcome by facial recognition systems. Thus, in these embodiments active disruption is a key feature. Further advantages will be apparent to a person of skill in the art practicing the teaching and the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations pointed out in the description and appended claims.

While embodiments that use the personal gear are described in this specification and in the figures as exemplary embodiments, it should be understood that this teaching can be adapted to apply to other personal gear (or modules), such as wearable and holdable gear, including a baseball cap, other hat, visor, jewelry, or mobile phone and/or its case, as examples, that are used alone or together. For example, a mobile phone case may provide IR emissions towards a person's face and the resulting disruption may be enhanced by the bottom of a bill of a cap or visor that has IR reflectors or its own IR emissions.

### BRIEF DESCRIPTION OF THE DRAWINGS

FIG. 1 is a perspective front-side view of an embodiment of the invention.

FIG. 2 is a perspective back-side view of an embodiment of the invention.

FIG. 3 is a perspective front-side view of additional embodiments of the invention worn on a person's head, including an embodiment with IR LED emitters on the front of the frames, and an embodiment with an IR LED on the side of the frames.

FIG. 4 is a schematic diagram showing certain component placement of an embodiment of the invention.

FIG. 5 is a schematic diagram showing connections between certain components of an embodiment of the invention.

FIG. 6 is a schematic diagram showing certain component placement in the left frame arm of an embodiment of the invention.

FIG. 7 is a diagram showing IR LED placement in an embodiment of this invention.

FIG. 8 is a a diagram showing IR LED placement in an eyeglasses frame embodiment of this invention.

FIG. 9 is a diagram showing IR LED placement in an handheld IR LED emitter or module embodiment of this invention.

FIG. 10 in a diagram showing an IR emitter embodiment attached to a mobile phone case.

FIG. 11 is a diagram showing different personal gear embodiments of this invention, including a cap, visor, lapel pin, necklace, another necklace, and a VR/AR headset.

### DETAILED DESCRIPTION OF THE INVENTION

The invention provides personal geal or modules that can disrupt biometric systems (e.g., facial recognition systems) and in some embodiments comprise multiple (e.g., 8-22, but more or less can also be used) infrared LEDs that are infrared disrupters, heat dissipation, and a power source that includes a power controller, among other components, features and uses. The personal gear or modules in some embodiments can incorporate and/or be used in conjunction with additional biometric system disrupters.

The invention also describes methods for discreetly counteracting facial recognition camera systems and their algorithms. These methods use the embodiments of the personal gear or modules of this invention. Such methods provide for privacy protection against such systems

In the personal gear or module embodiments, a wide variety of personal gear or modules can be used, and such embodiments may have a finish, fit, and comfortable weight distribution. In certain embodiments, the personal gear or modules are constructed using lightweight, heat-resistant polycarbonate or an alternative thermally conductive polymer and they have a matte black finish to enhance discretion.

In certain embodiments, the personal gear or modules include: (a) a matte black or other finish to maintain a low-profile and stylish appearance for some devices; (b) for any clothing, an ergonomic fit, to help provide comfort for extended wear (e.g., for about 3 hours or more without significant discomfort); and/or (d) a comfortable or otherwise tolerable weight distribution that is carefully designed so that the battery and LEDs do not create too much discomfort for the user for extended wear or use.

The infrared disrupter used in some embodiments is comprised of IR LED components and in certain examples of embodiments they are comprised of multiple IR LED emitters that are of (a) a certain type (e.g., high-efficiency, 850 nm IR LED emitters with a 120-degree beam angle), (b) a power output of each LED of between about 50 mW and about 1 W, and an exemplary power output of each LED of about 1 W, totaling 3 W across the device), (c) a placement with LEDs on the top of the front of the device or otherwise providing IR emissions to or in the proximity of the face, (d) an activation mechanism (e.g., a concealed micro-switch within the personal gear or modules), and (e) an operational duration (e.g., designed to last between about 1.5 to about 3 hours per charge, or longer, depending on usage and environmental conditions).

The personal gear or modules preferably include provisions (e.g., components, capabilities features) for heat dissipation. In certain embodiments the personal gear or modules include heat dissipation provisions that comprise one or more of: (a) ventilation slots (e.g., slots strategically placed along the top of the front of the personal gear or modules to dissipate heat from the IR LED emitters), (b) micro-perforations (e.g., micro-perforations along the top of the personal gear or modules to allow passive airflow over the embedded components), (c) an advantageous material choice (e.g. a thermally conductive composite that helps distribute heat away from sensitive areas), and/or (d) temperature regulation sensors (e.g., sensors that are integrated to monitor and prevent overheating beyond safe or uncomfortable limits by adjusting the infrared disrupter and/or to maximize battery life).

The personal gear or modules preferably include provisions (e.g., components, capabilities, features) for providing power and charging. This may comprise (a) one or more batteries (e.g., one or more rechargeable lithium-ion batteries, each embedded in the personal gear or modules, and more preferably one 3.7V lithium-ion rechargeable battery with a capacity of about 300 mAh to about 500 mAh), (b) one or more charging ports (e.g., a concealed USB-C port, located on the underside of the personal gear or modules), (c) efficient power use by operation of a power controller (e.g., a printed circuit board design that balances IR disrupter power consumption with maximum facial recognition disruption while maintaining a safe temperature or temperature range), (d) a micro-switch (e.g., a low-profile switch on the inner surface of personal gear or modules), and (e) automatic power control using the power controller (e.g., an auto-shutoff function when the device is inactive to preserve battery life). A battery management system (BMS) may also be provided to increase the capability and efficiency of the battery.

Examples of printed circuit boards integrate several components, including current-limiting resistors for LEDs, a battery management system for safe charging and power regulation, and a driver circuit to ensure consistent LED performance.

Examples of electronic component layout includes the IR LED emitters positioned at the top of the front of the personal gear or modules and each IR LED angled to provide coverage of the face and having a 120-degree beam angle; a battery embedded in the personal gear or modules with wiring routed through the personal gear or modules; a PCB, located in the personal gear or modules, and connecting the LEDs, battery and USB-C port; the USB-C port positioned on the underside of the personal gear or modules for discreet recharging; and a micro-switch located on the inner side of the personal gear or modules for easy access.

In examples of the personal gear or modules embodiments, the component layout will include (a) IR LED emitters positioned on the top of the front of the personal gear or modules for advantageous facial coverage, (b) one or more batteries discreetly embedded within the personal gear or modules to balance weight distribution, (c) a PCB (Printed Circuit Board) power controller located within the personal gear or modules, handling LED control and power distribution, (d) provisions for heat dissipation, including vents in the personal gear or modules and micro-perforations in the personal gear or modules to enhance airflow, (e) a micro-switch concealed within the personal gear or modules and used for user activation, (f) a USB-C port hidden under or otherwise in the personal gear or modules for easy, discreet charging, and (g) temperature regulation sensors that monitor LED heat output and work with other components to adjust power accordingly.

An example of organization of the components is [Battery]-->[PCB]-->[Switch]-->[LED Driver]-->[Infrared LEDs]-->[Temperature Regulation Sensors].

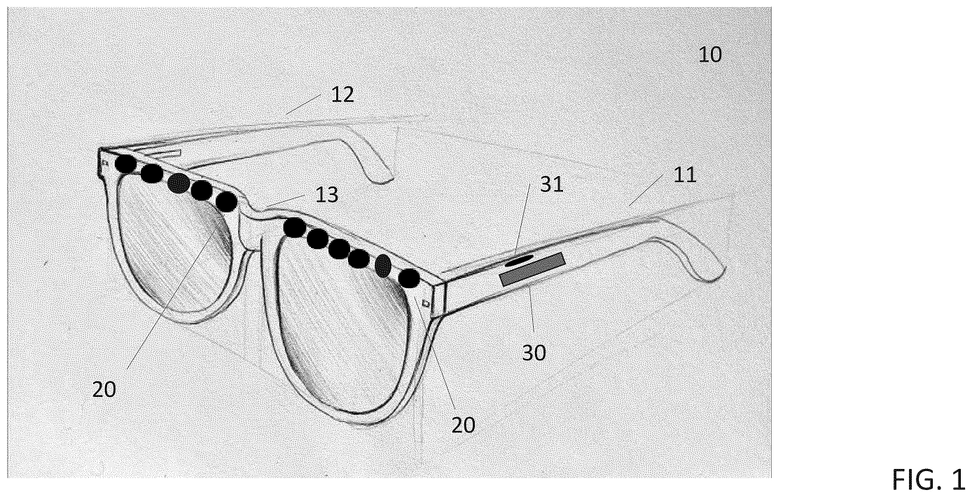

FIG. 1 is a perspective front side view of a schematic of an embodiment of an eyeglasses frame of this invention. It shows an example of the eyeglasses frame 10 and examples of the placement of rows of IR LED emitters 20, a battery 30, and a charging port 31. The eyeglasses frame has a left-side arm 11 that is worn near a wearer's left-side temple, a right-side 12 arm that is worn near a wearer's right-side temple, and a center bridge 13. This figure is illustrative only: various and other emitter wavelengths, placements and arrangements may be used.

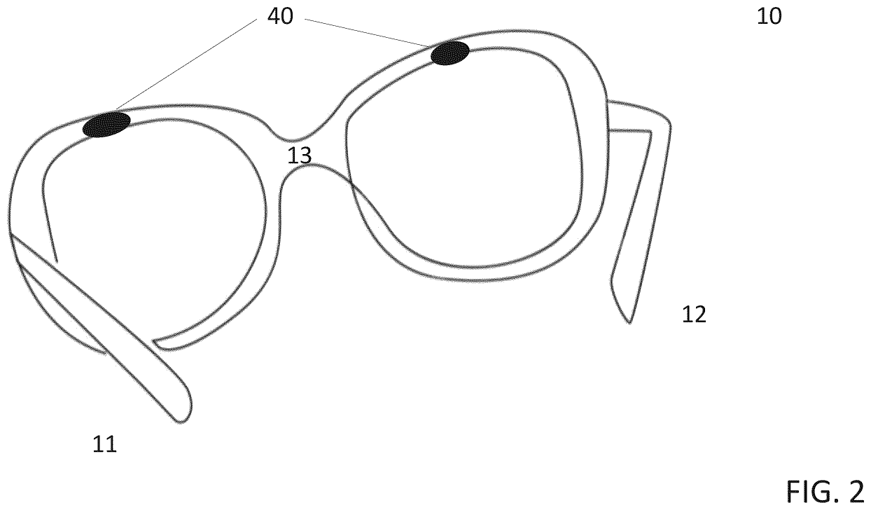

FIG. 2 is a perspective back side view of a schematic of an embodiment of an eyeglasses frame of this invention. It shows an example of the eyeglasses frame 10 and examples of the placement of ventilation slots 40. The eyeglasses frame has a left-side arm 11 that is worn near a wearer's left-side temple, a right-side 12 arm that is worn near a wearer's right-side temple, and a center bridge 13. This figure is illustrative only: various and other emitter wavelengths, placements and arrangements may be used.

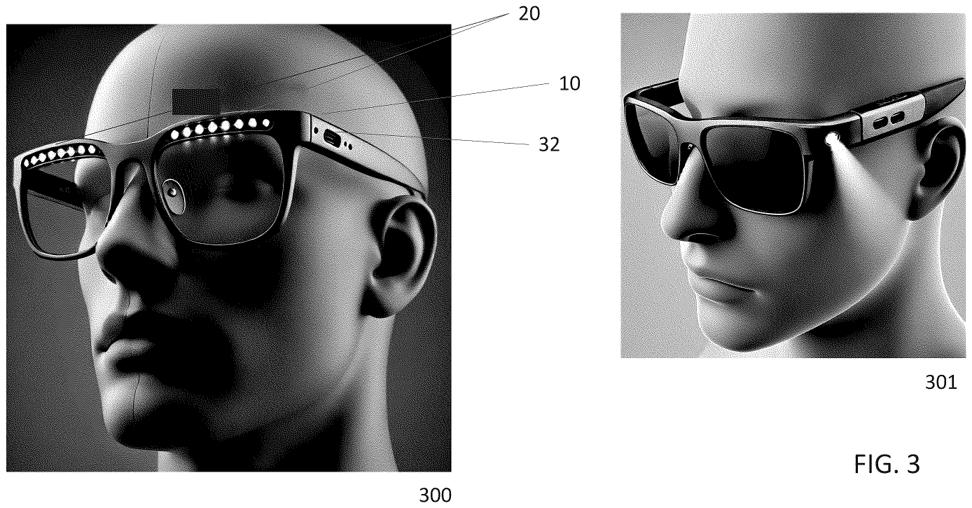

FIG. 3 includes two perspective front side views of drawings of two embodiments of eyeglasses frames of this invention on a wearer's head. The left side 300 shows two rows of IR LED emitters 20 and a power on (or on/off button) 32 on a frame. The right side 301 shows an IR LED on the side of a frame. Another IR LED (not shown) is on the other side of the frame. Other wavelength IR LED emitters can also be used in either embodiment. This figure is illustrative only: various and other emitter wavelengths, placements and arrangements may be used.

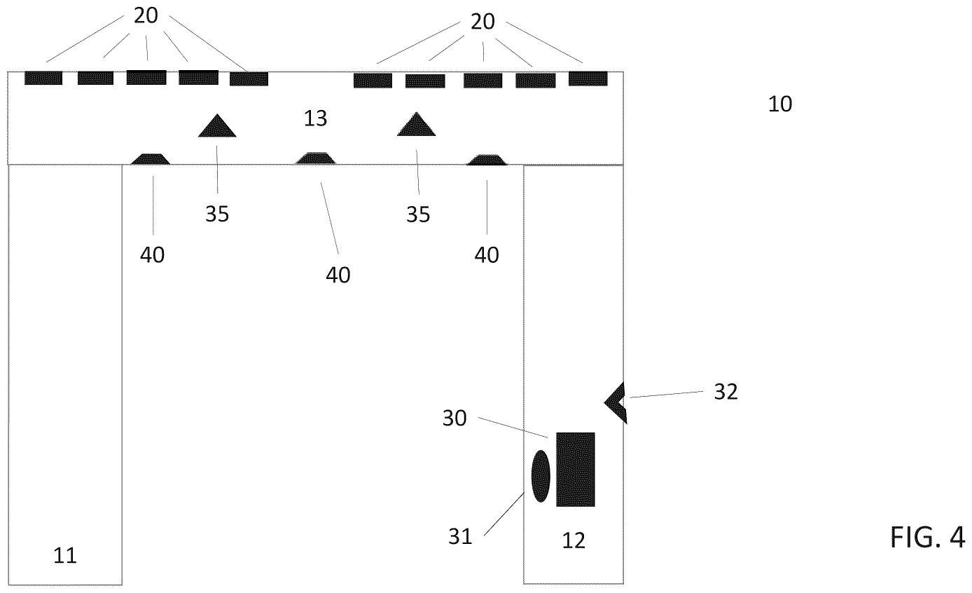

FIG. 4 is a schematic diagram showing the placement of certain components of this invention in an eyeglasses frame 10. It shows examples of the placement of rows of IR LED emitters 20, temperature sensors 35, ventilation slots 40, a battery 30, a charging port 31 and a micro-switch port. The eyeglasses frame has a left-side arm 11 that is worn near a wearer's left-side temple, a right-side 12 arm that is worn near a wearer's right-side temple, and a center bridge 13. This figure is illustrative only: various and other emitter wavelengths, placements and arrangements may be used.

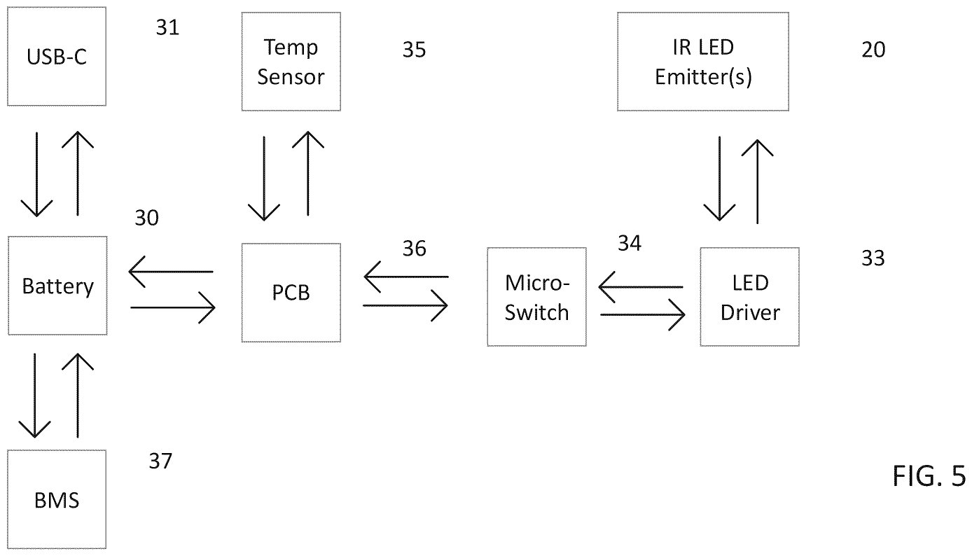

FIG. 5 is a schematic diagram of certain of the connections between examples of components of an embodiment of this invention. It shows an example of the battery 30, battery management system or BMS 37, port and charger 31, LED driver 33, micro-switch 34, temperature sensor 35, PCB power controller 36, and IR LED emitters 20. A PWM module may be integrated into this diagram (e.g., as part of a PCB 36, LED Driver 33, or as a separate component or incorporated into another component) to provide adaptive logic with a thermal sensor feedback loop. This figure is illustrative only: various and other emitter wavelengths, placements and arrangements may be used.

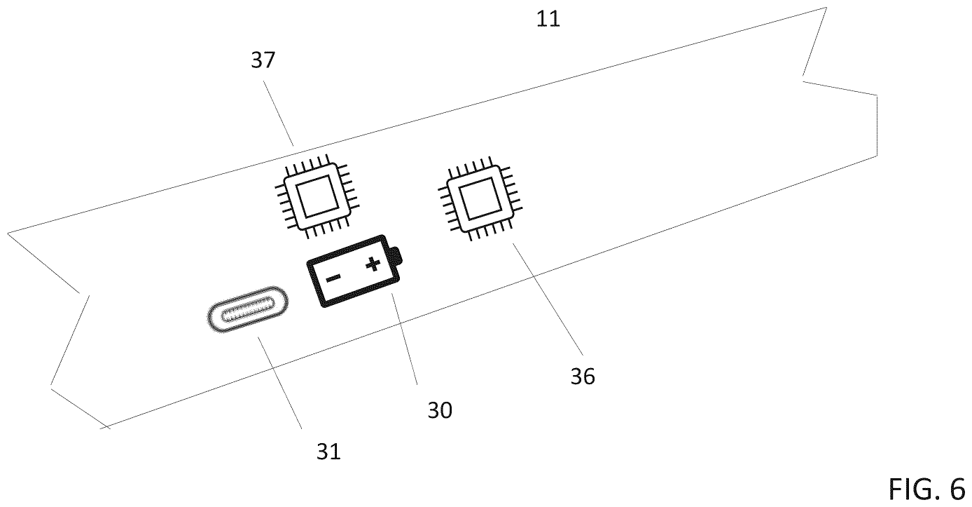

FIG. 6 is an exploded view of a schematic of a portion of the interior of a left-side eyeglasses frame arm 11, illustrating certain of the internal components of an embodiment of this invention, showing the integration of a PCB power controller 36, a battery 30, a BMS or battery management system 37, and a charging port 31. This figure is illustrative only: various and other emitter wavelengths, placements and arrangements may be used.

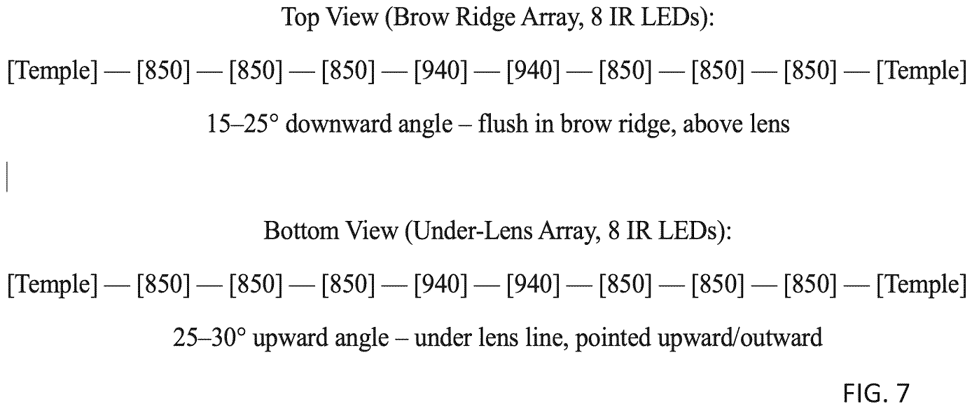

FIG. 7 is a diagram showing IR LED placement in an embodiment of eyeglasses frames of this invention. This figure is illustrative only: various and other emitter wavelengths, placements and arrangements may be used.

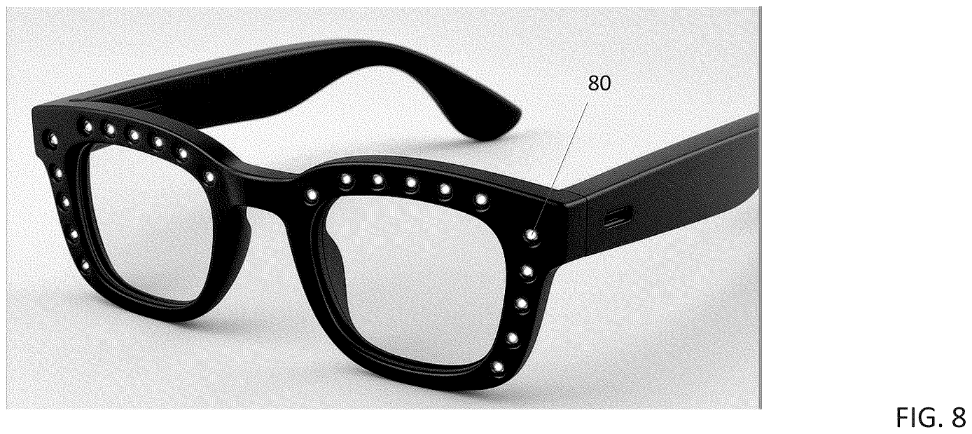

FIG. 8 is a front side view of an embodiment of an eyeglasses frames with IR LED emitters 80 arranged on the top and the outside side of the frames. Other wavelength IR LED emitters can also be used. This figure is illustrative only: various and other emitter wavelengths, placements and arrangements may be used.

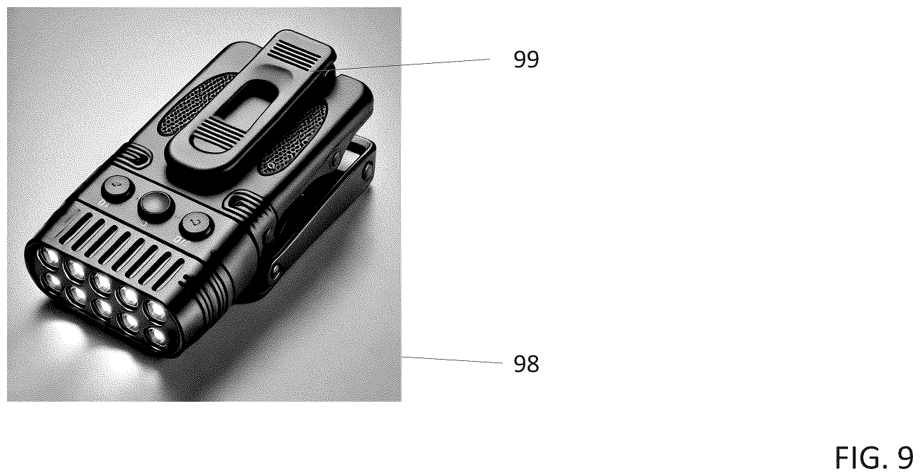

FIG. 9 is a diagram showing examples of IR LED placement in a handheld IR LED emitter or module embodiment 98 of this invention, the handheld having a clip 99 to attach it to clothing. This figure is illustrative only: various and other emitter wavelengths, placements and arrangements may be used.

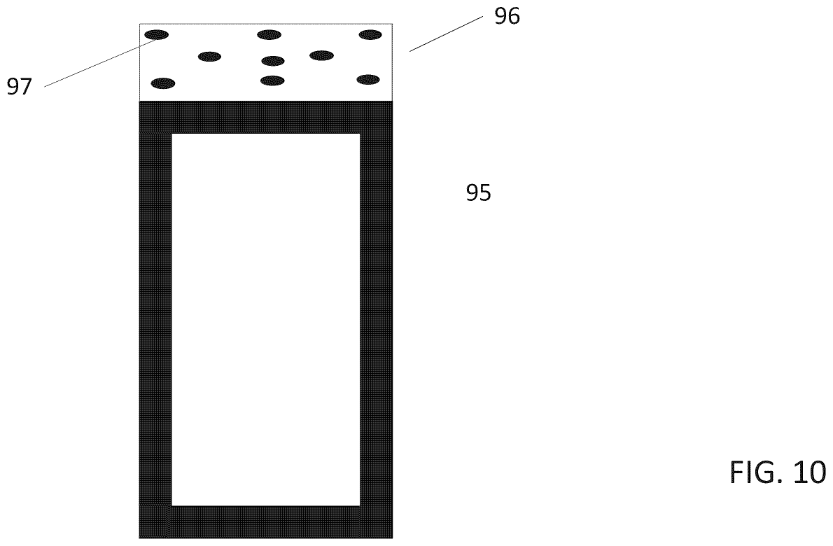

FIG. 10 in a diagram showing an IR emitter 97 embodiment, wherein the embodiment 96 is attached to the top of a mobile phone case 95. This figure is illustrative only: various and other emitter wavelengths, placements and arrangements may be used.

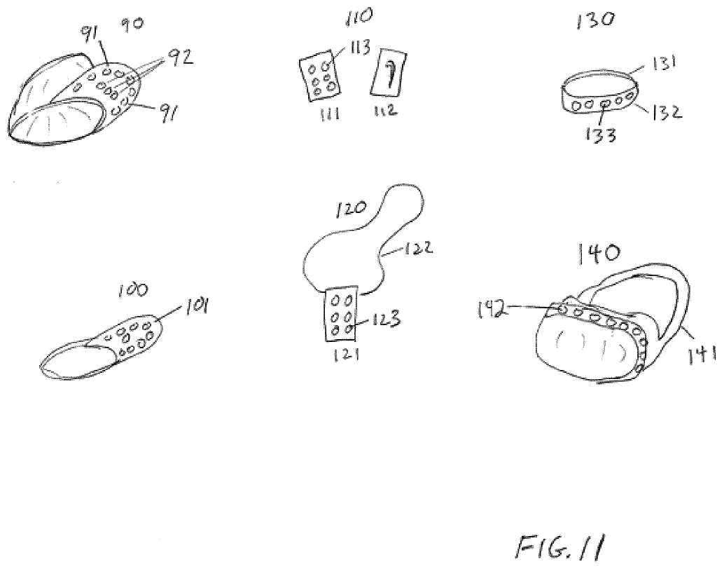

FIG. 11 is a diagram showing different personal gear embodiments of this invention, including a cap 90 with one set of IR LED emitters 91 and a second set of IR LED emitters 92; a visor 100 with IR LED emitters 101; a lapel pin 110, showing the front portion 111 containing IR LED emitters 113 and a back portion 112; a necklace 120 with a decorative item 121 and IR LED emitters 123 and a necklace chain 122; another necklace 130 with a rear portion 131, and a front-side portion 132 with IR LED emitters 133, as well as the rear section 131; and a VR/AR headset 140 with a rear strap portion 141 and a row of IR LED emitters 142. This figure is illustrative only: various and other emitter wavelengths, placements and arrangements may be used.

In certain embodiments, personal gear (wearable or holdable clothing, eyeglasses frames, headgear (e.g., hats), jewelry, handheld device, mobile phones or cases, tablets and other similar items used by persons) or modules for a user are provided that disrupt facial landmark detection of the user's face by a facial recognition system. The personal gear or modules comprise: (a) multiple IR LED emitters, each IR LED emitters attached to the personal gear or modules and capable of emitting IR light around or in proximity to the user's face; (b) a power source for providing power to each of the IR LED emitters, the power source comprising multiple power source components that work in concert. The power source components comprise: (i) a high-capacity rechargeable lithium battery, which battery is integrated within the personal gear or modules, and which battery provides power that is used by each of the IR LED emitters; (ii) a USB-C charging interface, which charging interface is positioned within the personal gear or modules, and which charging interface charges the battery; (iii) a battery management system, which battery management system is integrated within the personal gear or modules and is connected to the battery, and which battery management system works with other power source components to regulate power distribution, intensity of each of the IR LED emitters, and heat dissipation; (iv) multiple heat dissipators, the dissipators comprising ventilation slots and micro-perforations in the personal gear or modules that dissipate heat to prevent overheating of each of the IR LED emitters; (v) temperature regulation sensors, which sensors are embedded in the personal gear or modules, and which sensors work with other power source components to adjust the output of each of the IR LED emitters based on temperature to prevent overheating of each of the IR LED emitters; (vi) a dynamic power controller that works with other power source components to adjust the intensity of each of the IR LED emitters to maximize facial recognition disruption while preserving battery life; and (vii) an electrical circuit connecting the battery, charging interface, battery management system, sensors, and each of the IR LED emitters.

The personal gear or modules of these embodiments also comprises: (c) wherein the multiple IR LED emitters disrupt the facial landmark detection by the facial recognition system under various light conditions. The personal gear or modules perform disruption in a discreet manner. By discreet, it is meant the personal gear or modules do not immediately look to a casual viewer or passerby like a facial recognition system disrupter but instead looks like normal personal gear that is not out of the ordinary.

In addition, the personal gear or modules of these embodiments may further comprise a battery that is a lithium-ion or lithium-polymer battery with a capacity of about 300 mAh to about 500 mAh, a voltage of about 3.7V, and is about 4 mm to about 6 mm thick and about 40 mm in length, and/or wherein the battery management system further provides; (a) overcharge protection to ensure safe recharging; and (b) an automatic shut-off of each of the IR LED emitters when they are inactive to save power. In some of these embodiments, the battery management system and the dynamic power controller are provided on a single printed circuit board. In some of these embodiments, the power source further comprises a voltage regulator that maintains a steady approximately 3.7V output for each of the IR LED emitters, and in some embodiments, the power source further comprises current-limiting resistors that prevent excess power draw from each of the IR LED emitters.

In some of these embodiments, the power source further comprises pulse modulation control that provides pulsing IR LED operation to reduce continuous power drain and extend battery life. In some of these embodiments, the power source further comprises a power-saving mode that limits the intensity and/or duration of IR LED use to extend battery life. In some of these embodiments, each IR LED emits at about a 800 nm to about a 950 nm wavelength, or in some at about a 850 nm wavelength or about a 940 nm wavelength. In some of these embodiments, each IR LED emits at about a 120-degree beam angle. In some of these embodiments, some or all of the IR LED emitters emit in a non-repeating sequence to avoid prediction, mapping or adaptation by the facial recognition system.

In other examples of embodiments, methods of disrupting facial landmark detection by a facial recognition system are provided. The methods comprise: (a) wearing personal gear or modules comprising a power source that can be powered on to provide power to infrared light sources embedded in the personal gear or modules; (b) powering on the personal gear or modules to provide the power to the infrared light sources from the power source; (c) providing infrared light from infrared light sources towards the facial landmark detection by the facial recognition system; (d) disrupting the facial landmark detection by the facial recognition system using the infrared light from the infrared light sources.

In these methods, (i) the infrared light sources comprise multiple IR LED emitters, each IR LED emitters embedded into the personal gear or modules; (ii) the power source for providing power to each of the IR LED emitters, the power source comprising multiple power source components that work in concert, the power source components comprising: (a) a high-capacity rechargeable lithium battery, which battery is integrated within the personal gear or modules, and which battery provides power that is used by each of the IR LED emitters; (b) a USB-C charging interface, which charging interface is positioned within the personal gear or modules, and which charging interface charges the battery; (c) a battery management system, which battery management system is integrated within the personal gear or modules and is connected to the battery, and which battery management system works with other power source components to regulate power distribution, intensity of each of the IR LED emitters, and heat dissipation; (d) multiple heat dissipators, the dissipators comprising ventilation slots and micro-perforations in the personal gear or modules that dissipate heat to prevent overheating of each of the IR LED emitters; (e) temperature regulation sensors, which sensors are embedded in the personal gear or modules, and which sensors work with other power source components to adjust the output of each of the IR LED emitters based on temperature to prevent overheating of each of the IR LED emitters; (f) a dynamic power controller that work with other power source components to adjust the intensity of each of the IR LED emitters to maximize facial recognition disruption while preserving battery life; and (g) an electrical circuit connecting the battery, charging interface, battery management system, sensors, and each of the IR LED emitters.

In some of these methods, the battery is a lithium-ion or lithium-polymer battery with a capacity of about 300 mAh to about 500 mAh, a voltage of about 3.7V, and is about 4 mm to about 6 mm thick and about 40 mm in length. In some of these methods the battery management system further provides; (a) overcharge protection to ensure safe recharging; and (b) an automatic shut-off of each of the IR LED emitters when they are inactive to save power. In some of these methods, the battery management system and the dynamic power controller are provided on a single printed circuit board. In some of these methods, the power source further comprises a voltage regulator that maintains a steady approximately 3.7V output for each of the IR LED emitters.

In some of these methods, the power source further comprises current-limiting resistors that prevent excess power draw from each of the IR LED emitters. In some of these methods, the power source further comprises pulse modulation control that provides pulsing IR LED operation to reduce continuous power drain and extend battery life. In some of these methods, the power source further comprises a power-saving mode that limits the intensity and/or duration of IR LED use to extend battery life. In some of these methods, each IR LED emits at about a 800 nm to about a 950 nm wavelength, and in some of these methods each IR LED emits at about a 850 nm wavelength or at about a 940 nm wavelength. In some of these methods, each IR LED emits at about a 120-degree beam angle. In some of these methods, each IR LED emits in a non-repeating sequence to avoid prediction, mapping or adaptation by the facial recognition system.

In still other examples of methods of this invention, methods are provided for avoiding the identification of a person's face by a facial recognition system. These methods comprise: (a) providing pulses of infrared light around or in proximity to a person's face using personal gear or modules, the personal gear or modules comprising: (i) multiple IR LED emitters, each IR LED emitters embedded into the personal gear or modules; (ii) a power source for providing power to each of the IR LED emitters, the power source comprising multiple power source components that work in concert, the power source components comprising: (1) a high-capacity rechargeable lithium battery, which battery is integrated within the personal gear or modules, and which battery provides power that is used by each of the IR LED emitters; (2) a USB-C charging interface, which charging interface is positioned within the personal gear or modules, and which charging interface charges the battery; (3) a battery management system, which battery management system is integrated within the personal gear or modules and is connected to the battery, and which battery management system works with other power source components to regulate power distribution, intensity of each of the IR LED emitters, and heat dissipation; (4) multiple heat dissipators, the dissipators comprising ventilation slots and micro-perforations in the personal gear or modules that dissipate heat to prevent overheating of each of the IR LED emitters; (5) temperature regulation sensors, which sensors are embedded in the personal gear or modules, and which sensors work with other power source components to adjust the output of each of the IR LED emitters based on temperature to prevent overheating of each of the IR LED emitters; (6) a dynamic power controller that work with other power source components to adjust the intensity of each of the IR LED emitters to maximize facial recognition disruption while preserving battery life; and (7) an electrical circuit connecting the battery, charging interface, battery management system, sensors, and each of the IR LED emitters.

These other methods further comprise: (b) disrupting the image of the person's face captured by the facial recognition system with the pulses of infrared light so that the facial recognition system fails to identify the person's face.

In some of these other methods, the battery is a lithium-ion or lithium-polymer battery with a capacity of about 300 mAh to about 500 mAh, a voltage of about 3.7V, and is about 4 mm to about 6 mm thick and about 40 mm in length. In some of these other methods, the battery management system further provides; (a) overcharge protection to ensure safe recharging; and (b) an automatic shut-off of each of the IR LED emitters when they are inactive to save power. In some of these other methods, the battery management system and the dynamic power controller are provided on a single printed circuit board. In some of these other methods, the power source further comprises a voltage regulator that maintains a steady approximately 3.7V output for each of the IR LED emitters. In some of these other methods, the power source further comprises current-limiting resistors that prevent excess power draw from each of the IR LED emitters. In some of these other methods, the power source further comprises pulse modulation control that provides pulsing IR LED operation to reduce continuous power drain and extend battery life. In some of these other methods, the power source further comprises a power-saving mode that limits the intensity and/or duration of IR LED use to extend battery life.

In some of these other methods, each IR LED emits at about a 800 nm to about a 950 nm wavelength and in some of these other methods each IR LED emits at about a 850 nm wavelength or a 940 nm wavelength. In some of these other methods, each IR LED emits at about a 120-degree beam angle. In some of these other methods, each IR LED emits in a non-repeating sequence to avoid prediction, mapping or adaptation by the facial recognition system.

The subject matter of this disclosure is now described with reference to the following examples. These examples are provided for the purpose of illustration only, and the subject matter is not limited to these examples, but rather encompasses all variations which are evident as a result of the teaching provided herein.

### EXAMPLE 1

This example describes certain of the components, capabilities and features of certain of the examples of embodiments of this invention. These include:
1. Personal gear or modules with embedded infrared disrupters that are multiple high-powered IR LED emitters, each emitting at a disrupting (e.g., 850 nm, 940 nm or other) wavelength and with a 120-degree beam angle, arranged in a multi-point emission system, and positioned along the top of the front of the personal gear or modules to disrupt facial landmark detection.
3. A stealth design, wherein the infrared components are fully flush-mounted, ensuring the personal gear or modules appear like conventional gear. The personal gear or modules may have a matte black finish for aesthetic discretion.
4. One or more heat dissipators embedded in the personal gear or modules that are ventilation slots and/or micro-perforations integrated in the personal gear or modules for cooling the infrared disrupters (i.e., IR LED emitters) without affecting aesthetics.
5. Temperature regulation sensors embedded in the personal gear or modules that monitor and adjust IR LED output based on the temperature, and working with other related components. In addition, the personal gear or modules is constructed from heat-resistant, thermally conductive polymer for durability and comfort.
6. An embedded power source that includes a high-capacity rechargeable 3.7V lithium-ion (or lithium-pulse) battery of 300 mAh-500 mAh that is ultra-thin and flexible, a concealed USB-C charging interface that is used to recharge the battery, a hidden micro-switch for activation, and a power controller (e.g., LED driver) that provides power to the infrared disrupters (i.e., the IR LED emitters). The power distribution to the IR LED emitters may also include a voltage regulator that maintains a steady 3.7 output for consistent IR LED brightness, current-limiting resistors that prevent excess power draw from IR LED emitters, and/or pulse modulation control wherein the pulsing IR LED operation reduces continuous power drain and extends battery life.

The power cables for these components can be discreetly routed through the personal gear or modules where the IR LED emitters are positioned. A microcontroller can be used to regulate the IR LED emitters intensity dynamically, and a compact BMS board (see below) can be used to protect against overcharging and heat issues.
7. A Battery Management System (BMS) that regulates power distribution, IR LED intensity, heat dissipation, and works with other related components. It may include a smart power controller that dynamically adjusts IR LED intensity to conserve battery life, overcharge protection to ensure safe recharging via the USB-C charging interface, thermal sensors that monitor temperature and regulate power to prevent overheating, and/or an auto-shutoff feature when the IR LED emitters are inactive to save power. The personal gear or modules in some embodiments have a the battery management system that comprises an automatic shut-off when the personal gear or modules are not in use and a passive mode for power conservation that does not degrade the disruptive capability of the personal gear or modules.
8. Wearable and ergonomic for a sufficient amount of time (e.g., for about 3 hours or longer) using a lightweight, durable design for extended wear with prescription or non-prescription lenses.
9. Multi-environment functionality that is effective in low-light conditions and daylight, leveraging high-powered IR emissions to interfere with camera sensors.
10. Automated power management using a self-regulating and dynamic power controller that automatically adjusts IR intensity and heat dissipation dynamically as conditions of duration and use change and which maximizes facial recognition disruption while preserving battery life.

### EXAMPLE 2

Methods of using the components, capabilities and features of these examples of embodiments of Example 1 to interfere with facial recognition systems include wearing the personal gear or modules, turning them on so that the infrared disrupter is operational, and facing or otherwise being exposed to a facial recognition system, wherein the facial recognition system is defeated and cannot identify the wearer of the personal gear or modules.

### EXAMPLE 3

In this example, the anti-facial recognition personal gear or modules incorporate a total of 16 IR LED emitters (near-IR emitters) flush-mounted inside custom personal gear or modules. The IR LED layout consists of two horizontal arrays of LEDs concealed along the personal gear or modules-an upper array and a lower array-designed to be virtually invisible to onlookers yet highly effective against IR-sensitive cameras. Twelve LEDs (e.g., 850 nm, 940 nm and/or other) and four additional LEDs (e.g., 850 nm, 940 nm and/or other) are strategically distributed to maximize infrared output while minimizing visible signature. The emitters are internally recessed (i.e., discreet), so there is no external visibility or glow from the personal gear or modules during operation (e.g., in some embodiments 850 nm diodes provide a faint red output that is hidden, and 940 nm diodes that are inherently covert). This stealth configuration allows the glasses to appear ordinary to the human eye, while actively confounding facial recognition systems that rely on IR illumination.

Each row of IR LED emitters contains 8 IR LED emitters mounted from along the personal gear or modules inner rim. The top row of 8 LEDs is embedded in the brow portion of the personal gear or modules. These top-row LEDs are angled downward by 15-25° toward the wearer's face. This downward tilt focuses IR light onto the upper face (eyes and nose region) and forward toward cameras below the eye-line. The bottom row of 8 LEDs is mounted just under the eyes, along the lower personal gear or modules interior, and angled upward by 25-30° (and slightly outward) to illuminate the lower face (nose, mouth, chin) and upward toward cameras above the eye-line. This dual-row angular placement creates an overlapping 120° vertical arc of coverage (approximately)-effectively flooding the entire face with IR light from both above and below. By covering a wide vertical span, the system eliminates any dark shadows under the brow, nose, or jaw that IR cameras could use to discern 3D facial contours. Both LED rows sit flush with the personal gear or modules's inner surface, preserving a sleek appearance and ensuring no protrusion or visible LED elements externally.

To achieve a balance between IR power and stealth, in this particular embodiment the layout uses 850 nm LEDs at the outer zones of the personal gear or modules and 940 nm LEDs at the central zones. The higher-output 850 nm emitters are positioned toward the left and right edges of each row (near the temples) where maximum IR intensity (“punch”) is needed for wide-angle coverage. The central emitters (near the midpoint of the personal gear or modules, around the nose bridge area) are the 940 nm type, which are “covert IR” LEDs producing no visible red glow—ideal for stealth directly in front of the wearer's eyes. This zoning ensures that the most visible parts of the array (center of the face) use fully invisible IR, while the peripheral units provide additional IR illumination strength (850 nm LEDs, which cameras are most sensitive to. All 16 LEDs combined provide approximately a 180° horizontal field of IR illumination coverage, blanketing the wearer's face in IR light from ear to ear. This broad, diffuse IR flood overwhelms the imaging sensors of infrared cameras, effectively obscuring facial features. By emitting in the near-infrared spectrum beyond human vision (~740 nm and up), the glasses blind or oversaturate IR-sensitive cameras without any visible distraction to the wearer or others. The result is a full-face IR glow (captured by surveillance cameras) that washes out distinguishable landmarks, preventing reliable face detection or 3D mapping. Importantly, the arrangement is calibrated such that no single point on the face is under-lit-the multi-angle IR exposure eliminates characteristic shadows and flattens the appearance of facial geometry under IR, defeating recognition algorithms. Other combinations of different IR LEDs can be used.

FIG. 7 shows a layout diagram of the IR LED placement in the eyeglasses frames of this example. Sixteen IR LED's are used, eight on the top of the frames (flush in the brow ridge and above the lenses) and eight on the bottom of the frames (under the lens).

Each “[850]” in FIG. 7 denotes a high-output 850 nm IR LED; each “[940]” in FIG. 7 denotes a covert 940 nm IR LED. Outer-zone 850 nm LEDs provide strong IR intensity for wide 180° coverage, while the central 940 nm LEDs ensure no visible light emission in the critical front-central field. All diodes are concealed inside the frame thickness, with their emission directed through IR-transparent frame material.

Continuous operation of high-power IR LED emitters can generate significant heat-for example, a typical IR LED can overheat in just a few seconds of constant drive. To prevent thermal buildup while preserving performance, the glasses employ an adaptive thermal modulation system controlled by an onboard microcontroller. The microcontroller actively monitors the temperature of the IR LED diodes (via integrated thermistors or diode junction temperature sensing) and dynamically adjusts the strobe pulse frequency and duty cycle of the LED driving signals. Rather than driving the LEDs in steady-state, the controller drives them in a rapid pulsed IR strobe within a range of approximately 5-20 Hz. This means the IR LED emitters blink on and off faster than the human eye can perceive (infrared being invisible regardless), but fast enough to appear as a near-constant flood to a camera. The duty cycle (the ON vs. OFF time ratio of each pulse) is modulated based on real-time temperature feedback: if the LEDs'temperature approaches a defined threshold, the controller automatically shortens the ON duration or lengthens the OFF interval of pulses to reduce heat accumulation. Conversely, when temperature is within safe limits, the system can use a higher duty cycle (longer pulses) to maximize IR output. This adaptive PWM-based drive ensures the LEDs operate within safe thermal limits at all times, avoiding overheating or damage.

Crucially, the thermal modulation is designed not to compromise the personal gear or modules'anti-facial-recognition effectiveness. The microcontroller maintains the strobing within the optimal disruption frequency range of 5-20 Hz, which is fast enough to continuously interfere with camera imaging. At these pulse rates, surveillance camera frames are consistently saturated or disrupted by IR bursts, maintaining the “facial disruption integrity” of the system (i.e., the face remains washed out in IR on the camera feed). In essence, the LED driver circuitry controls the IR light output and strobes it at an appropriate frequency and duty cycle for this application, finding a balance between maximum optical output and thermal safety.

The adaptive logic leverages PWM thermal management techniques: temperature sensors feed into a control loop that adjusts LED PWM duty cycle to counteract any rise in junction temperature. By reducing the duty cycle when the LEDs get too warm, the system lowers the average power dissipation (allowing the diodes to cool) while still emitting periodic IR flashes. This approach improves the stability and reliability of the IR emitters under all conditions, effectively extending LED lifespan and preventing performance degradation. In summary, the adaptive thermal modulation ensures that the anti-recognition personal gear or modules deliver a consistent, effective IR output for facial masking, without overheating, through intelligent real-time adjustment of strobe frequency and duty cycle based on LED temperature. This guarantees that the device remains safe and functional over prolonged use, all while maintaining its full disruptive capability against facial recognition systems.

### EXAMPLE 4

FIG. 8 shows another embodiment of an array of IR LED emitters on the front of eyeglasses frames. One of the IR LED emitters is identified as 80. This array is across the top of the front of the frames and the sides of the front of the frames. It should be understood that the IR LED emitters can be placed anywhere on the frames, in any number, as long as disruption of facial recognition systems is achieved.

### EXAMPLE 5

In these embodiments, the personal gear or modules with disruptive IR LED emitters are worn or positioned within proximity to the face and the personal gear or modules s function independently of, or as part of, a larger biometric defense system, including but not limited to the personal gear or modules used with other IR disruptive devices that may include facewear, headgear, jewelry, smart accessories (e.g., mobile phones), and/or handheld form factors (e.g., devices comprising computer components), among other types of devices.

In certain of these embodiments, protection against biometric data harvesting beyond facial recognition is also provided. This may include disruption of eye-tracking, gaze analysis, 3D depth mapping, iris scans, and/or other biometric data collection techniques. In some of these embodiments, the device is configured to interfere with, obstruct, and/or degrade acquisition of biometric data including but not limited to facial recognition, gaze tracking, iris scanning, 3D depth mapping, and/or photoplethysmography.

In other embodiments, the personal gear or modules with disruptive IR LED emitters are worn or otherwise oriented and used with additional IR emitter modules that attach to other hardware that may include detachable modules, clip-on emitter systems, and/or integration into existing smartglass products.

### EXAMPLE 6

In these embodiments, the personal gear or modules with IR LED emitters are configured to emit IR in a manner that disables, corrupts, or saturates the raw sensor input of imaging systems, such that no post-processing, image correction, AI inference, or machine learning model can restore facial feature data to a recognizable state.

### EXAMPLE 7

In these embodiments, the IR LED emitters are in the form of arrays and are placed on the side of personal gear or modules. In other embodiments, the IR LED emitters are placed to provide full, wrap-around 360 degree coverage of the user's head. In this latter embodiment, the personal gear or modules may require extensions to cover the back of the head. By different placement of IR LED emitters on the devices used, 360 degree (or less) coverage of the face, top of head, sides of head, and entire head, as well as other parts of the body, can be achieved with embodiments of this invention. This can be achieved in approximately 2 dimensional planes or 3 dimensional spheres of IR coverage.

### EXAMPLE 8

In these embodiments, the emission pattern of the IR LED emitters is randomized and/or dynamically modulated in real time via onboard artificial intelligence (“AI”) and/or sensor feedback, to prevent adaptation by camera-based or AI-driven facial recognition systems. This provides coverage for random, dynamic, and/or AI-controlled IR emission patterns and prevents circumvention through predictable pulsing or timing attacks.

In certain of these embodiments, all or only some (a subset) of the IR LED emitters are activated to obtain disruption. This can include targeted IR LED emitters to certain areas and/or targeted IR LED emitters of certain wavelengths and/or angles. This may obtain minimized power consumption and/or a variable emission signature that may enhance the ability to avoid a facial recognition system defeating the disruption caused by the personal gear or modules.

### EXAMPLE 9

In these embodiments, the personal gear or modules have IR LED emitters that maintain facial recognition disruption in varying lighting conditions, including direct sunlight, low-light, infrared-rich, or infrared-poor (e.g., low-infrared containing, such as an enviroment with no or low amounts of natural sunlight (e.g., indoors without windows or windows with low-e coatings)) environments.

### EXAMPLE 10

In these embodiments, the personal gear or modules further comprise a camera detection subsystem integrated (e.g., embedded with connections to power source components) into the personal gear or modules and the power source components. The subsystem automatically activates the IR disruption system of the personal gear or modules upon detection of an imaging sensor, lens reflection, infrared focus mechanism, location known to have a camera, and/or other indication a camera is in proximity. This can be provided by integration of camera detection sensors on the personal gear or modules and permitting proximity-based activation. It may prevent circumvention by activating the device only when under surveillance.

### EXAMPLE 11

In these embodiments, the personal gear or modules are effective against several types of detection/recognition systems, such as those in vehicle dashcams, drones, and/or automated public imaging systems, among others, and are not limited to person-to-camera interactions. In these embodiments, the IR disruption system of this invention is operable during exposure to stationary, mobile, and/or airborne imaging systems, including but not limited to dashcams, drones, surveillance towers, and/or automated biometric kiosks, among others.

EXAMPLE 12

In certain embodiments of this invention, temperature control systems are used, such as a thermal feedback control loop with Pulse Width Modulation (PWM). These are systems that use temperature measurements to adjust the power that is being delivered to, for example, a cooling system (e.g., fan). Instead of a simple on/off switch, PWM rapidly cycles the power, varying the on-time (duty cycle) to provide a precise, time-averaged power level. These methods are often more efficient and accurate than on/off control, as it may prevent large temperature swings and power spikes.

Such a PWM thermal feedback control loop can be incorporated in a PCB (e.g., FIGS. 5, 36) and/or an LED Driver (FIGS. 5, 33), with input from a Temp Sensor (e.g., FIGS. 5, 35), or as a separate component or incorporated into other components, as examples.

An exemplary PWM thermal feedback control loop is comprised of four main parts: (1) a sensor or connection to such (e.g., a temperature-sensitive component, such as a thermistor or thermocouple, measures the current temperature of the system or component); (2) a controller (e.g., often a microcontroller (like an Arduino) or a dedicated PID controller chip, which has the job of calculating the difference (error) between the measured temperature and the desired setpoint temperature); (3) an actuator or connection to such (e.g., an element that is controlled by the PWM signal, which could be a solid-state relay for a cooling element, a fan motor, or a thermoelectric cooler, among other devices); and (4) a PWM generator (e.g., a feature of the controller that creates a square-wave output signal, wherein the duty cycle of this signal is adjusted by the controller to manage the average power sent to the actuator).

An exemplary PWM thermal feedback control loop process is a continuous cycle of sensing, calculating, and adjusting. For example, these steps can comprise sensing (e.g., a temperature sensor measures the current temperature); comparison (e.g., a controller compares the current temperature to the user (person, software, AI)-defined setpoint temperature); error calculation (e.g., the controller calculates the error as the difference between the current and defined setpoint temperature); control action (e.g., using the error value, a control algorithm—such as Proportional-Integral-Derivative (PID) algorithm—determines the necessary adjustment); PWM adjustment (e.g., the algorithm's output is used to set the PWM duty cycle, wherein a larger error (e.g., the system is much hotter than the setpoint) results in a longer “on” time for the PWM signal, sending more power to the cooling element); actuation (e.g., the PWM signal drives the cooling element, delivering an averaged power that adjusts the system's temperature); and looping (e.g., the temperature sensor immediately detects the change, and the process repeats, constantly correcting for any drift from the setpoint).

The use of such PWM thermal control in certain embodiments may provide some advantages, such as: increased efficiency (e.g., unlike on/off control, which can cause large energy spikes, PWM may deliver only the necessary average power, reducing wasted energy); greater accuracy (e.g., by constantly and proportionally adjusting power, PWM can maintain temperatures with a much higher degree of precision than a simple on/off switch); reduced noise and wear (e.g., for cooling fans, PWM control allows the fan speed to be adjusted based on the thermal load, and the fans run quieter when the system is cool and increase speed only when necessary, which also prolongs the life of the motor); and/or smoother control (e.g., thermal systems often have a large thermal mass and react slowly to changes, while the rapid PWM switching happens much faster than the system's thermal response, allowing for a smooth and stable average power delivery that prevents overshooting or undershooting the target temperature).

### EXAMPLE 13

In these embodiments, a backup or alternative power source (“auxiliary power source”) is provided for the device (e.g., embedded in the device and connected to the power source components). Certain of these embodiments use an emergency capacitor and/or have a dual-power design with another power source (e.g., a second battery of a smaller, larger or the same size). This auxiliary power source in some embodiments is configured to provide short-duration IR output during main battery failure and/or system interruption. In some embodiments, the personal gear or modules also contain embedded within them an auxiliary power source that is used to provide power to the IR LED emitters if a main or principal power source is not operational.

### EXAMPLE 14

This example is directed to certain embodiments that comprise personal gear or modules for a user to wear and methods for using them.

The personal gear or modules are capable of disrupting a facial recognition system that uses facial landmark detection of the user's face. These personal gear or modules comprise: (a) multiple IR LED emitters, each of the IR LED emitters attached (e.g., embedded within) to the personal gear or modules and capable of emitting IR light near (e.g., in the proximity) of the user; and a (b) a power source for providing power to each of the IR LED emitters, the power source comprising multiple power source components that work in concert.

The power source components comprise: (i) a high-capacity rechargeable lithium battery, said battery being integrated within the personal gear or modules, and said battery providing power that is used by each of the IR LED emitters; (ii) a USB-C charging interface, said charging interface being positioned within the personal gear or modules, and said charging interface charging the battery; (iii) a battery management system, said battery management system being integrated within the personal gear or modules and being connected to the battery, said battery management system working with other power source components to regulate power distribution, intensity of each of the IR LED emitters, and heat dissipation; (iv) multiple heat dissipators, said heat dissipators comprising ventilation slots and/or micro-perforations in the personal gear or modules that dissipate heat to prevent overheating of each of the IR LED emitters; (v) temperature regulation sensors, said sensors being embedded in the personal gear or modules, and said sensors working with other power source components to adjust the output of each of the IR LED emitters based on temperature to prevent overheating of each of the IR LED emitters; (vi) a dynamic power controller, said power controller working with other power source components to adjust the intensity of each of the IR LED emitters to maximize the disruption of the facial recognition system and preserving battery life; and (vii) an electrical circuit connecting the battery, the charging interface, the battery management system, the sensors, and each of the IR LED emitters.

In these embodiments, when activated, some or all of the multiple IR LED emitters disrupt the facial recognition system under various light conditions, and the personal gear or modules are discreet and comfortably wearable for at least three hours at a time.

Selections of the examples of components and capabilities include each of the following, taken individually: (1) wherein the battery is a lithium-ion or lithium-polymer battery with a capacity of about 300 mAh to about 500 mAh, a voltage of about 3.7V, and is about 4 mm to about 6 mm thick and about 40 mm in length; (2) wherein the battery management system further provides (a) overcharge protection to ensure safe recharging of the battery and (b) an automatic shut-off of each of the IR LED emitters when they are inactive to save power; (3) wherein the battery management system further comprises an automatic shut-off when the personal gear or modules are not in use and a passive mode for power conservation that does not degrade the disruptive capability of the personal gear or modules; (4) wherein the battery management system and the dynamic power controller are provided on a single printed circuit board; (5) wherein the power source components further comprise a pulse width modulation thermal feedback control loop; (6) wherein the power source further comprises a voltage regulator that maintains a steady approximately 3.7V output for each of the IR LED emitters; (7) wherein the power source further comprises current-limiting resistors that prevent excess power draw from each of the IR LED emitters; (8) wherein the power source further comprises pulse width modulation control that provides pulsing IR LED operation to reduce continuous power drain and extend battery life; (9) wherein the power source further comprises a power-saving mode that limits the intensity and/or duration of IR LED use to extend battery life; (10) wherein each IR LED emits at a wavelength from about 780 nm to about 1100 nm wavelength; (11) wherein each IR LED emits at a wavelength from about 850 nm to about 940 nm wavelength; (12) wherein each IR LED emits at about a 120-degree beam angle; and/or (13) wherein each IR LED emits in a non-repeating sequence to avoid prediction, mapping, and/or adaptation by the facial recognition system.

Additional selections of the examples of components and capabilities also include the following, each taken individually: (14) wherein the emission pattern of the IR LED emitters is randomized and/or dynamically modulated in real time via onboard artificial intelligence (“AI”) and/or sensor feedback, to prevent adaptation by a camera-based and/or AI-driven facial recognition system; (15) wherein the personal gear or modules are used with other IR disrupter devices, the other IR disrupter devices comprising face ware, headgear, jewelry, smart accessories, and/or handheld form factors; (16) wherein the personal gear or modules are used with IR emitter modules comprising one or more IR LED emitters, wherein said IR emitter modules attach to other hardware, and wherein the other hardware comprises detachable modules, clip-on emitter systems, and/or integration into existing smartglass products; (17) wherein the IR LED emitters are configured to emit IR in a manner that disables, corrupts, and/or saturates the raw sensor input of imaging systems, such that no post-processing, image correction, AI inference, and/or machine learning model can restore facial feature data to a recognizable state; (18) wherein the IR LED emitters are placed on personal gear or modules to provide 360 degree coverage over at least a portion of the user's head; (19) wherein the power source components further comprise a pulse width modulation controller module that provides adaptive logic with a thermal sensor feedback loop; (20) wherein facial recognition system disruption is maintained in varying ambient lighting conditions, including direct sunlight, low-light, infrared-rich, and/or low-infrared environments; (21) wherein the eyeglasses personal gear or modules further comprise a camera detection subsystem that automatically activates the IR LED emitters of the personal gear or modules upon detection of an imaging sensor, lens reflection, and/or infrared focus mechanism; (22) wherein the personal gear or modules are further configured to interfere with, obstruct, and/or degrade acquisition of biometric data including but not limited to facial recognition, gaze tracking, iris scanning, 3D depth mapping, and/or photoplethysmography; (23) wherein the IR disruption is operable during exposure to stationary, mobile, and/or airborne imaging systems that comprise dashcams, drones, surveillance towers, and/or automated biometric kiosks; (24) wherein the personal gear or modules comprise thermally conducive, heat-resistant, IR transparent and/or IR diffusing materials; and/or (25) wherein an auxiliary power source is used to provide power to the IR LED emitters if the power source is not operational.

These examples of embodiments and selections can be used in methods of disrupting facial recognition systems, the methods comprising: (1) wearing the personal gear or modules; (2) powering on the personal gear or modules to provide the power to some or all of the IR LED emitters; (3) providing infrared light from some or all of the IR LED emitters in the proximity of the user or wearer; and (4) disrupting the facial recognition systems using the infrared light provided from some or all of the IR LED emitters.

These embodiments and selections also can be used in methods of avoiding the identification of a user's face by facial recognition systems, the methods comprising: (1) providing pulses of infrared light using the personal gear or modules; and (2) disrupting facial recognition systems with the pulses of infrared light provided by the personal gear or modules so that facial recognition systems fail to identify the user's face.

### EXAMPLE 15

In these embodiments, personal gear for disrupting facial recognition of a user's face is provided. It comprises: (a) a plurality of infrared emitters configured to emit near-infrared radiation within a range of about 780 to about 1100 nanometers; (b) a power subsystem operatively coupled to the emitters; (c) at least one controller configured to modulate emission intensity and/or timing, optionally in response to sensor input, to degrade or corrupt image capture of the user's face; and (d) thermal-management elements operatively coupled to the emitters; wherein, when activated, the emitted radiation disrupts facial recognition across varied ambient lighting conditions.

Examples of selections of components and features of these personal gear embodiments include: (1) wherein the emitters operate at about 850 nm and/or about 940 nm; (2) wherein the emitters are arranged to provide wraparound or substantially 360 degree coverage; (3) wherein the controller implements pulse-width modulation with thermal feedback; (4) wherein activation occurs automatically in response to detection of a camera or imaging sensor; (5) wherein disruption extends to gaze tracking, iris scanning, depth mapping, or photoplethysmography; and (6) wherein the personal gear further comprises a housing that comprises heat-resistant, IR-transparent or IR-diffusing polymer.

Method embodiments of this personal gear example can include methods of disrupting facial recognition of a user's face. These methods comprise: positioning the personal gear relative to the user; activating the infrared emitters; and emitting radiation modulated to saturate or degrade image capture of the user's face such that facial recognition fails under varied lighting conditions.

### EXAMPLE 16

In these embodiments, an infrared emitter module configured to be worn with or attached to personal gear to disrupt facial recognition of a user's face is provided. It comprises: (a) a housing; (b) a plurality of infrared emitters configured to emit near-infrared radiation within a range of about 780 to about 1100 nanometers; (c) a power subsystem; (d) a controller configured to generate emission patterns including randomized or non-repeating sequences and/or patterns responsive to sensor input; and (e) thermal-management elements; wherein, when activated, the module disrupts facial recognition by corrupting raw image sensor data such that downstream processing cannot reliably reconstruct facial features.

Examples of selections of components and features of these infrared emitter modules include: (1) wherein the emitters operate at about 850 nm and/or about 940 nm; (2) wherein the emitters are arranged to provide wraparound or substantially 360 degree coverage; (3) wherein the controller implements pulse-width modulation with thermal feedback; (4) wherein activation occurs automatically in response to detection of a camera or imaging sensor; (5) wherein disruption extends to gaze tracking, iris scanning, depth mapping, or photoplethysmography; and (6) wherein the housing comprises heat-resistant, IR-transparent or IR-diffusing polymer.

Method embodiments of this infrared emitter module example can include methods of avoiding identification by a facial recognition system. These methods comprise: activating the infrared emitter module; and emitting randomized or sensor-responsive infrared patterns that prevent reliable reconstruction of facial features by image correction, artificial intelligence, or machine-learning systems.

### OTHER EMBODIMENTS

Although the present invention has been described with reference to teaching, examples and embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. Personal gear for disrupting facial recognition of a user's face comprising:
(a) a plurality of infrared emitters configured to emit near-infrared radiation within a range of about 780 nm to about 1100 nm;
(b) a power subsystem operatively coupled to the emitters;
(c) at least one controller configured to modulate emission intensity and/or timing, optionally in response to sensor input, to degrade or corrupt image capture of the user's face; and
(d) thermal-management elements operatively coupled to the emitters;
wherein, when activated, the emitted radiation disrupts facial recognition across varied ambient lighting conditions.

2. The personal gear of claim 1, wherein the emitters operate at about 850 nm and/or about 940 nm.

3. The personal gear of claim 1, wherein the emitters are arranged to provide wraparound or substantially 360 degree coverage.

4. The personal gear of claim 1, wherein the controller implements pulse-width modulation with thermal feedback.

5. The personal gear of claim 1, wherein activation occurs automatically in response to detection of a camera or imaging sensor.

6. The personal gear of claim 1, wherein disruption extends to gaze tracking, iris scanning, depth mapping, or photoplethysmography.

7. The personal gear of claim 1, further comprising a housing that comprises heat-resistant, IR-transparent or IR-diffusing polymer.

8. A method of disrupting facial recognition of a user's face, comprising:
positioning personal gear according to claim 1 relative to the user;
activating the infrared emitters; and
emitting radiation modulated to saturate or degrade image capture of the user's face such that facial recognition fails under varied lighting conditions.

9. An infrared emitter module configured to be worn with or attached to personal gear to disrupt facial recognition of a user's face, comprising:
(a) a housing;
(b) a plurality of infrared emitters configured to emit near-infrared radiation within a range of about 780 nm to about 1100 nm;
(c) a power subsystem;
(d) a controller configured to generate emission patterns including randomized or non-repeating sequences and/or patterns responsive to sensor input; and
(e) thermal-management elements;
wherein, when activated, the module disrupts facial recognition by corrupting raw image sensor data such that downstream processing cannot reliably reconstruct facial features.

10. The infrared emitter module of claim 9, wherein the emitters operate at about 850 nm and/or about 940 nm.

11. The infrared emitter module of claim 9, wherein the emitters are arranged to provide wraparound or substantially 360 degree coverage.

12. The infrared emitter module of claim 9, wherein the controller implements pulse-width modulation with thermal feedback.

13. The infrared emitter module of claim 9, wherein activation occurs automatically in response to detection of a camera or imaging sensor.

14. The infrared emitter module of claim 9, wherein disruption extends to gaze tracking, iris scanning, depth mapping, or photoplethysmography.

15. The infrared emitter module of claim 9, wherein the housing comprises heat-resistant, IR-transparent or IR-diffusing polymer.

16. A method of avoiding identification by a facial recognition system, comprising:
activating the infrared emitter module of claim 9; and
emitting randomized or sensor-responsive infrared patterns that prevent reliable reconstruction of facial features by image correction, artificial intelligence, or machine-learning systems.
